(19) United States
(12) Patent Application Publication
(10) Pub. No.: US 2026/0138269 A1
(43) Pub. Date: May 21, 2026

(54) APPARATUS AND METHOD WITH ROBOT DRIVING

(71) Applicant: Samsung Electronics Co., Ltd., Suwon-si (KR)

(72) Inventors: Taeoh HA, Suwon-si (KR); Hyunsoo CHA, Suwon-si (KR)

(73) Assignee: Samsung Electronics Co., Ltd., Suwon-si (KR)

(21) Appl. No.: 19/192,579

(22) Filed: Apr. 29, 2025

(30) Foreign Application Priority Data
Nov. 20, 2024 (KR) 10-2024-0166559

(51) Int. Cl. B25J 9/16

(52) U.S. Cl. CPC B25J 9/163; B25J 9/161; B25J 9/1666; B25J 9/1676

(57) ABSTRACT

A driving apparatus, an operating method thereof, and a neural network training method thereof are provided. The operating method includes generating safety constraint information based on obstacle information obtained by sensing based on a current waypoint, generating prediction data of a dual space from the safety constraint information and the current waypoint by using a pre-trained neural network model, and obtaining a next waypoint of the driving apparatus by performing spatial transformation on the prediction data.

### CROSS-REFERENCE TO RELATED APPLICATIONS

This application claims the benefit under 35 USC § 119(a) of Korean Patent Application No. 10-2024-0166559, filed on Nov. 20, 2024, in the Korean Intellectual Property Office, the entire disclosure of which is incorporated herein by reference for all purposes.

### BACKGROUND

### 1. Field

The following description relates to an apparatus and method with robot driving.

### 2. Description of Related Art

For a driving robot, it is critical not only to reach a predetermined destination but also to avoid obstacles along the route. In this context, an intermediate point used to facilitate reaching the destination is generally referred to as a waypoint.

In end-to-end robot driving, a next waypoint is generated using a policy model, which may be trained based on driving data collected form human operators in advance.

The trained policy model subsequently generates future waypoints in a manner analogous to human driving behavior. These generated waypoints are provided as inputs to a typical controller, which calculates driving control values to direct the robot along the desired path.

Various methods exist for configuring the policy model in end-to-end robot driving. One such method implements a policy based on a diffusion model. The diffusion model, specifically a denoising diffusion probabilistic model, generates final data through a denoising process.

The denoising process uses conditional input and seed noise, gradually removing noise from the seed noise to generate data. A deep learning network is employed to learn the noise removal process. When used as policy mode, the diffusion model receives a target location as input and generates a next waypoint from the current state via the denoising process.

The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes generating safety constraint information based on obstacle information obtained by sensing at a current waypoint; generating prediction data in a dual space from the safety constraint information and the current waypoint using a pre-trained neural network model; and detecting a next waypoint for a driving apparatus by performing spatial transformation on the prediction data.

The safety constraint information may include one or more parameters that linearly constrain a range of the prediction data.

The generating of the prediction data may include determining a dual function that transforms the current waypoint into a dual space is determined based on the one or more parameters.

The pre-trained neural network model may include a diffusion model, and the generating of the prediction data may include inputting random noise into the pre-trained neural network model.

The generating of the safety constraint information may include applying a predetermined algorithm to the obstacle information.

The method may further include moving the driving apparatus to the next waypoint in response to the driving apparatus moving to the current waypoint; and repeating the moving process to reach a predetermined target location.

The current waypoint and the next waypoint may be determined based on global positioning system (GPS).

In one general aspect, a method for training a neural network for a driving apparatus includes generating a driving data set including obstacle information and driving location information; generating safety constraint information from the driving data set; generating prediction data by inputting the safety constraint information, a waypoint of the driving apparatus, and random noise into the neural network; transforming a next waypoint of the driving apparatus into data of a dual space, based on the driving location information; and training the neural network based on an error between the prediction data and the transformed data.

The safety constraint information may include one or more parameters that linearly constrain a range of the prediction data.

The generating of the prediction data may include determining a dual function that transforms the waypoint into a dual space is determined based on the one or more parameters.

The generating of the prediction data may further include transforming the waypoint into the dual space using the dual function in the neural network; and denoising the transformed waypoint.

The neural network may include a diffusion model.

The transforming the next waypoint into the data of the dual space may include applying a dual function to each waypoint included in the driving location information.

The generating of the safety constraint information from the driving data set may include applying a predetermined algorithm to the obstacle information.

The generating of the prediction data may further include inputting information about a predetermined target location into the neural network; and generating a plurality of prediction data points up to the target location.

In one general aspect, provided is a non-transitory computer-readable storage medium storing code that, when executed by one or more processors, configures the one or more processors to perform the method described herein.

In one general aspect, a processor-implemented apparatus include one or more processors respectively comprising processing circuitry; and a memory storing code, which upon execution by the one or more processors, configures the one or more processors to: generating safety constraint information based on obstacle information obtained by sensing at a current waypoint; generating prediction data in a dual space from the safety constraint information and the current waypoint using a pre-trained neural network model; and detecting a next waypoint for the driving apparatus by performing spatial transformation on the prediction data.

The safety constraint information may include one or more parameters that linearly constrain a range of the prediction data; and the one or more processors may be further configured to move the driving apparatus to the next waypoint; and repeating the moving process to reach a predetermined target location.

For generating the prediction data, the one or more processors may be configured to determine a dual function that transforms the current waypoint into the dual space based on the one or more parameters.

The pre-trained neural network model may include a diffusion model; for generating the prediction data, the one or more processors may be further configured to input random noise into the pre-trained neural network model; and for generating the safety constraint information, the one or more processors are further configured to apply a predetermined algorithm to the obstacle information obtained.

Other features and aspects will be apparent from the following detailed description, the drawings, and the claims.

### BRIEF DESCRIPTION OF THE DRAWINGS

FIGS. 1A and 1B illustrate respective example driving path of a driving apparatus according to one or more embodiments.

FIG. 2 illustrates an example operating method of a driving apparatus according to one or more embodiments.

FIG. 3 illustrates an example method of determining a waypoint using a dual space according to one or more embodiments.

FIG. 4 illustrates an example operating function of a driving apparatus during operation according to one or more embodiments.

FIG. 5 illustrates an example training method of a neural network of a driving apparatus according to one or more embodiments.

FIG. 6 illustrates an example operation of each function for training a neural network according to one or more embodiments.

FIGS. 7A to 7C illustrate examples of driving of a driving apparatus according to one or more embodiments.

FIG. 8 illustrates an example of a driving apparatus according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component, element, or layer is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly defined herein.

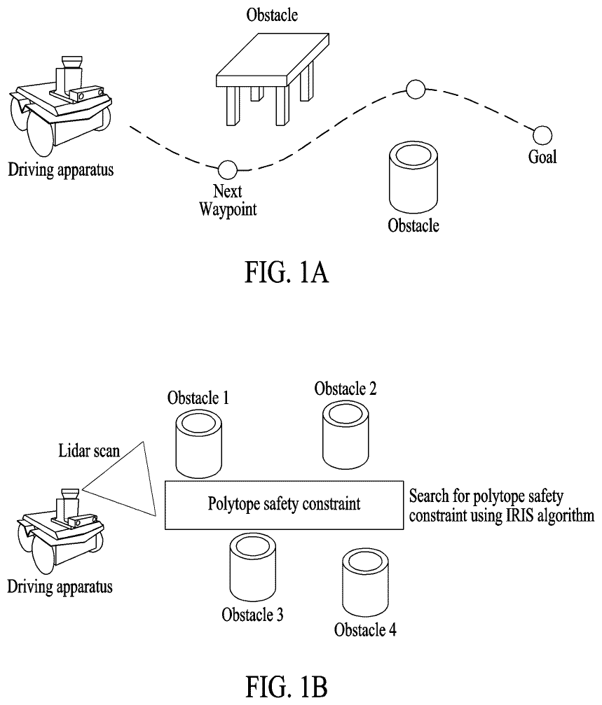

FIGS. 1A and 1B illustrate respective example driving path of a driving apparatus according to one or more embodiments.

FIG. 1A illustrates a method of moving the driving apparatus through one or more waypoints to a target location (a goal).

The driving apparatus (e.g., a driving robot) may first move to a set waypoint or an initial waypoint. When a next/subsequent waypoint is determined, the driving apparatus may move from the current waypoint to the next waypoint, thereby progressing toward the target location. Here, the waypoints may be selected/determined such that the driving apparatus may drive along a safe path, avoiding obstacles. Specifically, each waypoint may be chosen/determined within a safe area free of obstacles, and the safe area may be generated based on information input from a sensor of the driving robot.

As shown in FIG. 1B, when safety constraint information, which is derived from data indicating a safe area, is provided, the driving apparatus may determine the next waypoint using the safety constraint information. As a non-limiting example, the safety constraint information may include information about a polytope-shaped area/region in which the driving apparatus may move safely, by applying an iterative regional inflation by a semi-definite programming (IRIS) algorithm.

The IRIS algorithm may identify a location of an obstacle using a light detection and ranging (LiDAR) scan or similar methods and may represent information about the safe area for the driving apparatus to drive safely from a current location as linear constraint information. For example, when the waypoint is denoted as x, matrices A and b may be determined such that the linear constraint information Ax≤b are satisfied. The information obtained through the IRIS algorithm may be defined as the safety constraint information.

By using the safety constraint information obtained through this method, the driving apparatus can ensure that each waypoint complies with the safety constraint information. Consequently, by sequentially following/driving through the waypoints, the driving apparatus may safely reach the target location.

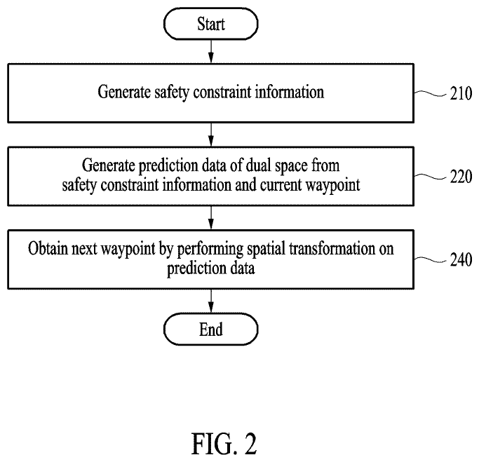

FIG. 2 illustrates an example operating method of a driving apparatus according to one or more embodiments.

The following operations may be performed sequentially or in parallel. For example, the order of the operations may vary, and at least two operations may be performed in parallel.

The driving apparatus may move along one or more waypoints and continue to a next generated waypoint. As the driving apparatus moves, location information of the driving apparatus and obstacle information detected/obtained by sensing may change. Hereinafter, an operating method of generating one waypoint is described.

In operation 210, the driving apparatus may generate safety constraint information based on obstacle recognition information/data obtained via sensor(s) at a current waypoint.

The driving apparatus may obtain information about surrounding obstacles based on information input from sensors such as LiDAR sensors. Upon receiving the obstacle information, the driving apparatus may generate safety constraint information defining a space/region within which the driving apparatus may move safely using a predetermined algorithm, such as the IRIS algorithm. According to the safety constraint information, a polytope-shaped area may be represented by linear information about a location.

Accordingly, the safety constraint information generated by the IRIS algorithm may include one or more parameters that linearly constrain a range of prediction data used for generating the next waypoint.

In operation 220, the driving apparatus may generate prediction data in a dual space using the safety constraint information and the current waypoint using a pre-trained neural network model.

A diffusion-based model may serve as a neural network.

The pre-trained neural network may receive information about the current waypoint, a final target location, the safety constraint information, and random noise. The network may progressively remove noise from the random noise to generate coordinates corresponding to a dual space representing the next waypoint.

The neural network may be trained by minimizing an error between the data transformed into a dual space and the prediction data output through the neural network, for waypoint(s) corresponding to an actual driving data set.

The prediction data for training may be obtained by transforming the current waypoint into a dual space using a dual function and subsequently denoising the transformed waypoint. The obtained prediction data may include coordinate information corresponding to the dual space.

Training of the neural network may be based on minimizing the error between the generated prediction data and the actual driving data set. To generate the prediction data, the dual function, which transforms the current waypoint into the dual space, may be determined based on one or more parameters representing a linear constraint.

The training method of the neural network is described in detail below.

In operation 230, the driving apparatus may obtain the next waypoint by performing a spatial transformation on the prediction data.

The driving apparatus may include an inverse transformation function of the dual function to convert the prediction data back into coordinates within the actual driving space. This inverse transformation function may be likewise determined by one or more parameters representing a linear constraint, and may use a gradient descent method.

The next waypoint generated by the inverse transformation function may be output in a format based on a global positioning system (GPS) coordinates. For example, the next waypoint may be expressed as GPS information.

The driving apparatus may follow the current waypoint and subsequently move to the next waypoint as generated. To facilitate this movement, the driving apparatus may include a controller that governs a means of transportation, such as wheels.

By repeatedly progressing from one waypoint to the next, the driving apparatus can safely reach a predetermined target location without colliding with obstacle(s).

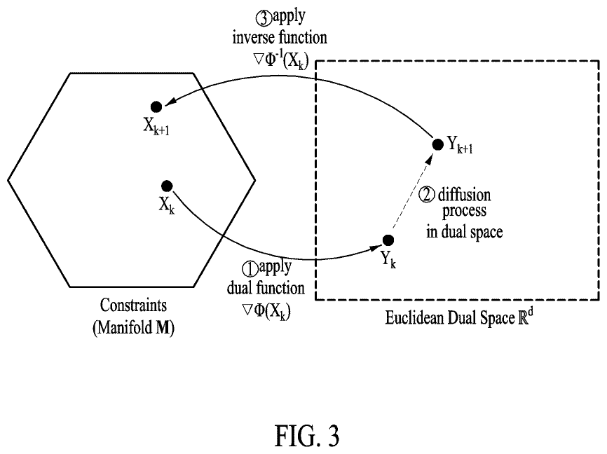

FIG. 3 illustrates an example method of determining a waypoint using a dual space according to one or more embodiments.

By obtaining a waypoint using dual space coordinates derived from safety constraint information in either three-dimensional or two-dimensional space, the waypoint may be generated within the safety constraint information.

A dual function may provide a waypoint Xₖ in a Euclidean dual space. A corresponding point may be represented as Yₖ. The dual function may be defined as shown in Equation 1, for example, below.

$$\begin{matrix}ϕ ( x ) = - {\sum }_{i = 1}^{m} log ( {b}_{i} - {a}_{i}^{T} x ) & y = ∇ ϕ ( x ) = {\sum }_{i = 1}^{m} \frac{1}{{b}_{i} - {a}_{i}^{T} x} {a}_{i} = {( \frac{1}{b - Ax} )}^{T} A\end{matrix} , \qquad Equation 1$$

Here, A and b denote values for the safety constraint information generated by the IRIS algorithm, and m denotes the number of elements/pieces of the safety constraint information. In Equation 1, ai denotes each i-th row vector of a matrix A, and bi denotes each i-th element of a vector b.

As shown in Equation 1, the dual function may use a gradient function to generate linear constraint information for the waypoint Xₖ.

In response to Yₖ being transformed into a dual space, it may undergo a denoising process by a diffusion model, resulting in a next waypoint Yₖ₊₁ in the dual space. An inverse transformation function may be defined as shown in Equation 2, for example, below.

$$∇ {ϕ}^{*} ( y ) = {arg min}_{x} {‖ y - {( \frac{1}{b - Ax} )}^{T} A ‖}_{2} \qquad Equation 2$$

According to Equation 2, a coordinate x corresponding to an actual space may be derived from a value y determined via the diffusion model. The coordinate x in Equation 2 may correspond to a waypoint Xₖ₊₁ of FIG. 3.

The inverse transformation function may be obtained using a gradient descent method.

By applying the inverse transformation function to the next waypoint Yₖ₊₁ derived from the dual space, the waypoint Xₖ₊₁ corresponding to the actual space may be obtained.

Training the diffusion model using the data transformed into the dual space via the dual function allows the generation of the coordinates of the dual space that comply with the safety constraint information associated with the transformed data.

While the diffusion model alone may not enforce output to comply with safety constraints, utilizing the dual space, as illustrated in the one or more embodiments, ensures that the output meets these constraints.

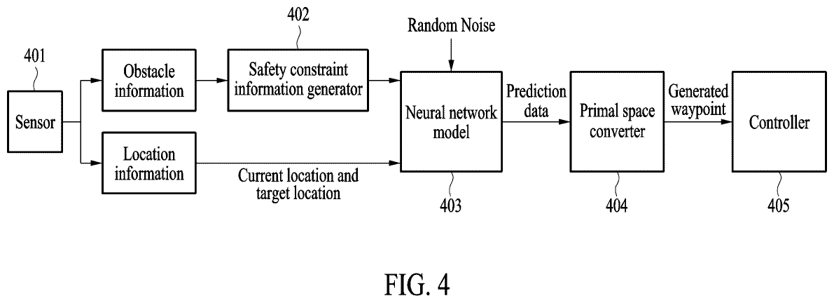

FIG. 4 illustrates an example operating function of a driving apparatus during operation according to one or more embodiments.

Obstacle and location information of the driving apparatus may be obtained through at least one sensor 401 integrated into the driving apparatus. The sensor 401 may include devices such as a GPS receiver, LiDAR sensor, camera, and the like.

The sensor 401 may acquire/obtain the obstacle information based on a location of the driving apparatus at each step for determining a next waypoint while the driving apparatus is in motion.

Safety constraint information may be generated based on the obstacle information obtained through a safety constraint information generator 402 within the driving apparatus. The safety constraint information generator 402 may include a program implementing an IRIS algorithm, and may generate/update the safety constraint information whenever new obstacle information is input.

A neural network model 403 may obtain information about a current location from a sensor, information about a target location corresponding to a final target, and the safety constraint information, to output prediction data used for deriving a next waypoint based on trained parameters.

The neural network model 403, which may be a diffusion model, may receive random noise as input and output the prediction data through a denoising process on the corresponding noise. The resulting prediction data may correspond to coordinates of a dual space.

Thus, the neural network model 403 may be trained to ensure compliance with the safety constraint information by performing the denoising process on the input random noise, thereby deriving the next waypoint in the dual space.

The prediction data generated by the neural network model 403 may be transformed into coordinates in the actual space using a primal space converter 404.

The primal space converter 404 may include an inverse transformation function for performing inverse transformation on the prediction data of the dual space transformed in the neural network model 403. The prediction data may be transformed into the next waypoint, which may be expressed as global locations, such as GPS coordinates.

The driving apparatus may move to the generated waypoint under the control of a controller 405. The driving apparatus may input the derived waypoint into the controller 405, which may control the driving apparatus to follow the waypoint. For example, the controller 405 of the driving apparatus may control a means of transportation such as wheels.

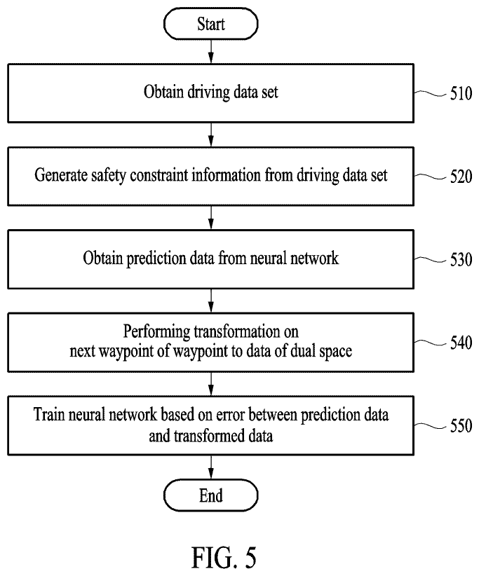

FIG. 5 illustrates an example training method of a neural network of a driving apparatus according to one or more embodiments.

The following operations may be performed sequentially or in parallel. For example, the order of the operations may change, and at least two operations may be performed in parallel. The neural network training method may be performed by a training apparatus, which may be a computing device including a memory and one or more processors.

In operation 510, the training apparatus may obtain a driving data set including obstacle information and driving location information.

Initially, the training apparatus may collect the driving data set as training data. The driving data set may include obstacle information according to a driving location of the driving apparatus, driving location information of the driving apparatus, and waypoint information corresponding to the driving apparatus's location(s).

In operation 520, the training apparatus may generate safety constraint information from the driving data set.

The training apparatus may recognize and analyze the obstacle information associated with each waypoint in the driving data set, to generate the safety constraint information at each waypoint. The safety constraint information may indicate a polytope-shaped area in which the driving apparatus may safely move using, for example, an IRIS algorithm.

The safety constraint information may include one or more parameters that linearly constrain a range of prediction data used for generating a next waypoint or subsequent waypoints.

In operation 530, the training apparatus may input the safety constraint information, the waypoint of the driving apparatus, and random noise into the neural network to generate prediction data.

To train the neural network, the training apparatus may input the safety constraint information, a corresponding waypoint, and a target location into the neural network. The neural network may obtain/output the prediction data that has undergone a denoising process from added random noise.

To generate the prediction data, a dual function, which transforms each waypoint to a dual space, may be determined based on one or more parameters representing a linear constraint.

The prediction data may be generated by transforming each waypoint into the dual space using the dual function, followed by a denoising process on the transformed waypoint.

In operation 540, the training apparatus may perform transformation on a next waypoint, derived from the driving data set, into dual space data based on the driving location information.

The training apparatus may transform the next waypoint based on the driving location information included in the driving data set into the data of the dual space so that the data of the dual space may be directly compared to the prediction data of the next waypoint generated by the neural network.

In operation 550, the training apparatus may train the neural network based on an error between the prediction data and the transformed data.

The training apparatus may train the neural network using the error between data in space of the dual space. The training may be performed by minimizing a loss function set for the training process, ensuring that the neural network minimizes the error between the prediction data and the transformed data.

Once trained, the trained neural network may generate the prediction data in the dual space for the next waypoint from the input random noise. Subsequently, by transforming the prediction data into coordinate data of an actual space using an inverse transformation function, the next waypoint of the driving apparatus may be generated. The inverse transformation function may refer to Equation 2 described above.

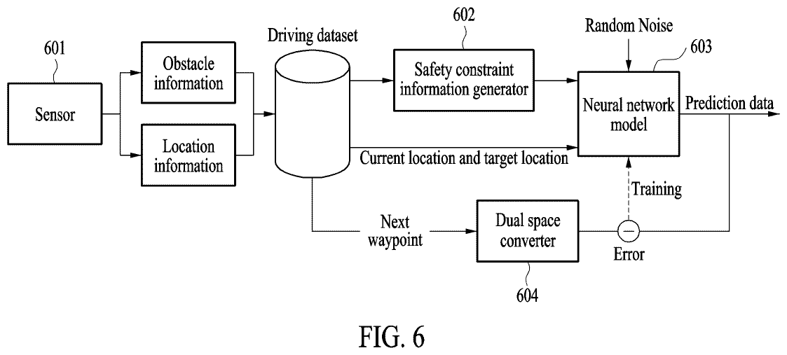

FIG. 6 illustrates an example operation of each function for training a neural network according to one or more embodiments.

The neural network may be trained by a training apparatus and based on an error between actual driving data and prediction data.

A sensor 601 may obtain obstacle and location information regarding the movement of the driving apparatus. As a non-limiting example, this information may include data on obstacles that are detected/recognized differently according to the movement of the driving apparatus, data on a location where the driving apparatus is moving, and data on waypoints according to the movement of the driving apparatus.

The obtained data may be assembled into a driving data set used for training the neural network.

The driving data set may be provided to a safety constraint information generator 602. The safety constraint information generator 602 may generate safety constraint information including parameters that may linearly limit a range of the prediction data via an IRIS algorithm.

The safety constraint information generator 602 may generate the safety constraint information based on the obstacle information detected at each location included in the driving data set.

The generated safety constraint information may be input into a neural network model 603. The neural network model 603 may receive, as input, information/data such as a waypoint of the driving apparatus corresponding to the safety constraint information and a target location of the driving apparatus, in addition to the safety constraint information. Through a denoising process applied to random noise, the neural network model 603 may derive the prediction data including information about a next waypoint that complies with the safety constraint information.

The prediction data may correspond to data in a dual space.

Furthermore, a dual space converter 604 may obtain a location of the next waypoint during actual driving. Subsequently, the waypoint may be transformed into dual space data so that the output from the neural network model 603, which is the data in the dual space, can be directly compared with the transformed data.

The training apparatus may use the actual driving data and the prediction data to train the neural network model 603, thereby reducing the error between the prediction data in the dual space output from the neural network model 603 and the transformed dual space data corresponding to the next waypoint.

The prediction data generated by the pre-trained neural network model 603 may be transformed into coordinates in an actual driving space using an inverse transformation function, and may be provided as a waypoint for navigation by the driving apparatus.

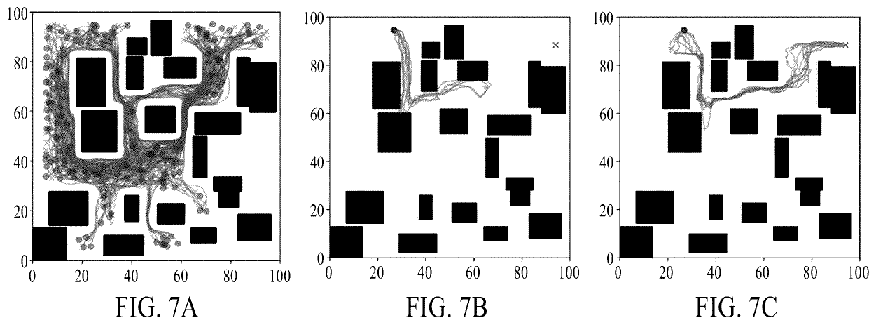

FIGS. 7A to 7C illustrate examples of driving of a driving apparatus according to one or more embodiments.

Referring to FIGS. 7A to 7C, black squares may represent obstacles, and a path is shown where the driving apparatus navigates between a start location and a target location.

FIG. 7A illustrates various driving examples for the driving apparatus, FIG. 7B illustrates an example using a conventional end-to-end controller, and FIG. 7C illustrates an example of the driving apparatus driving toward a waypoint that complies with safety constraint information using a trained diffusion model.

Neural network models illustrated in FIGS. 7B and 7C may be trained using multiple driving data sets collected from various start and arrival locations. Each neural network model may be provided with global location information for two-dimensional start and arrival points/locations and may be trained to reach the arrival location without collision.

As shown in FIG. 7B, an issue with existing end-to-end controllers may be that safety is not be guaranteed. Since deep learning-based training models operate as black boxes, they may not reliably generate safe waypoints. In cases of insufficient training data, unsafe waypoints, such as those leading to collision with obstacles, may be generated. To ensure safety, additional data confirming obstacle avoidance is necessary.

In contrast, FIG. 7C shows that, by restricting a policy model to comply with the safety constraint information at all times, the driving apparatus can operate safely without colliding with obstacles. The safety performance of the driving apparatus is thereby improved compared to conventional methods, as evidenced by its collision-free operation in FIG. 7C.

Quantitatively, FIG. 7B shows a collision probability of 30%, while FIG. 7C shows no collisions.

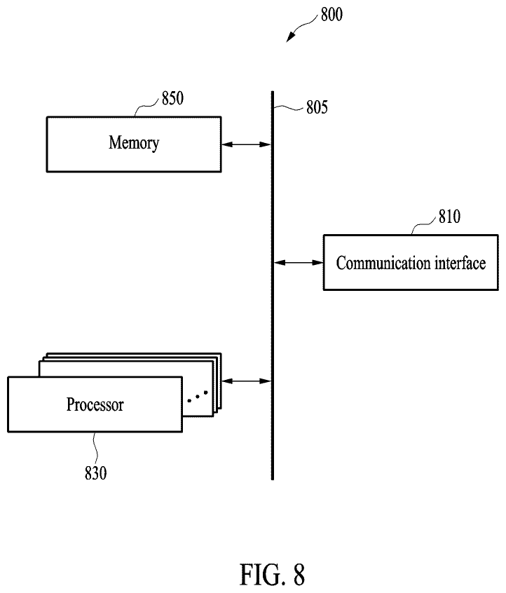

FIG. 8 illustrates an example driving apparatus according to one or more embodiments.

Referring to FIG. 8, a driving apparatus 800 may include a communication interface 810, one or more processors 830, and a memory 850. These components may be interconnected via a communication bus 805.

The communication interface 810 may receive driving-related data from sensors.

The one or more processors 830 may respectively comprise processing circuitry configured to determine a next waypoint based on the data received via the communication interface 810. The one or more processors 830 may derive the next waypoint using safety constraint information obtained from obstacle data and a current waypoint of the driving apparatus 800. For example, the next waypoint in a dual space may be determined from random noise input using a pre-trained neural network. The one or more processors 830 may transform the next waypoint in the dual space into actual space coordinates that comply with the safety constraint information.

The memory 850 may store various information generated during the one or more processors' program execution and encoding processes. Furthermore, the memory 850 may store diverse data and programs, and may include both volatile and non-volatile storages. The memory 850 may include a large-capacity storage medium such as a hard disk for high-capacity data storage.

In addition, the one or more processors 830 may perform the methods described with reference to FIGS. 1 through 7 or execute algorithms corresponding to these methods. The one or more processors 830 may be implemented as a hardware-implemented data processing device having a circuit that is physically structured to execute desired operations. For example, the desired operations may include code or instructions in a program. The one or more processors 830 may be implemented as, for example, a central processing unit (CPU), a graphics processing unit (GPU), and/or a neural network processing unit (NPU).

The one or more processors 830 may execute a program to control the driving apparatus 800 with program code to be executed by the one or more processors 830 stored in the memory 850.

The driving apparatuses, electronic devices, sensors, processors, memories, storage devices, cameras, storage devices, controllers, neural network models and interfaces, communication buses, sensor 401/601, safety constraint information generator 402/602, neural network model 403/603, converter 404/604, controller 405, communication interface 810, processors 830, memory 850, communication bus 805, and other apparatuses, devices, models, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processor-implemented method, the method comprising:
generating safety constraint information based on obstacle information obtained by sensing at a current waypoint;
generating prediction data in a dual space from the safety constraint information and the current waypoint using a pre-trained neural network model; and
detecting a next waypoint for a driving apparatus by performing spatial transformation on the prediction data.

2. The method of claim 1, wherein
the safety constraint information comprises one or more parameters that linearly constrain a range of the prediction data.

3. The method of claim 2, wherein,
the generating of the prediction data comprises determining a dual function that transforms the current waypoint into a dual space is determined based on the one or more parameters.

4. The method of claim 1, wherein
the pre-trained neural network model includes a diffusion model, and
the generating of the prediction data comprises inputting random noise into the pre-trained neural network model.

5. The method of claim 1, wherein
the generating of the safety constraint information comprises applying a predetermined algorithm to the obstacle information.

6. The method of claim 1, further comprising:
moving the driving apparatus to the next waypoint in response to the driving apparatus moving to the current waypoint; and
repeating the moving process to reach a predetermined target location.

7. The method of claim 1, wherein
the current waypoint and the next waypoint are determined based on global positioning system (GPS).

8. A method for training a neural network for a driving apparatus, the method comprising:
generating a driving data set including obstacle information and driving location information;
generating safety constraint information from the driving data set;
generating prediction data by inputting the safety constraint information, a waypoint of the driving apparatus, and random noise into the neural network;
transforming a next waypoint of the driving apparatus into data of a dual space, based on the driving location information; and
training the neural network based on an error between the prediction data and the transformed data.

9. The method of claim 8, wherein
the safety constraint information comprises one or more parameters that linearly constrain a range of the prediction data.

10. The method of claim 9, wherein,
the generating of the prediction data comprises determining a dual function that transforms the waypoint into a dual space is determined based on the one or more parameters.

11. The method of claim 10, wherein
the generating of the prediction data further comprises:
transforming the waypoint into the dual space using the dual function in the neural network; and
denoising the transformed waypoint.

12. The method of claim 8, wherein
the neural network includes a diffusion model.

13. The method of claim 8, wherein
the transforming the next waypoint into the data of the dual space comprises applying a dual function to each waypoint included in the driving location information.

14. The method of claim 8, wherein
the generating of the safety constraint information from the driving data set comprises applying a predetermined algorithm to the obstacle information.

15. The method of claim 8, wherein
the generating of the prediction data further comprises:
inputting information about a predetermined target location into the neural network; and
generating a plurality of prediction data points up to the target location.

16. A non-transitory computer-readable storage medium storing code that, when executed by one or more processors, configures the one or more processors to perform the method of claim 1.

17. A processor-implemented apparatus comprising:
one or more processors respectively comprising processing circuitry; and
a memory storing code, which upon execution by the one or more processors, configures the one or more processors to:
generate safety constraint information based on obstacle information obtained by sensing at a current waypoint;
generate prediction data in a dual space from the safety constraint information and the current waypoint using a pre-trained neural network model; and
detect a next waypoint for the driving apparatus by performing spatial transformation on the prediction data.

18. The apparatus of claim 17, wherein
the safety constraint information comprises one or more parameters that linearly constrain a range of the prediction data; and
the one or more processors are further configured to:
move the driving apparatus to the next waypoint; and
repeating the moving process to reach a predetermined target location.

19. The apparatus of claim 18, wherein,
for generating the prediction data, the one or more processors are configured to determine a dual function that transforms the current waypoint into the dual space based on the one or more parameters.

20. The apparatus of claim 17, wherein
the pre-trained neural network model includes a diffusion model;
for generating the prediction data, the one or more processors are further configured to input random noise into the pre-trained neural network model; and
for generating the safety constraint information, the one or more processors are further configured to apply a predetermined algorithm to the obstacle information obtained.
